(19) United States
(12) Patent Application Publication
(10) Pub. No.: US 2013/0257643 A1
(43) Pub. Date: Oct. 3, 2013

(54) RADAR APPARATUS, ON-BOARD RADAR SYSTEM, AND PROGRAM

(71) Applicant: HONDA ELESYS CO., LTD., Yokohama-shi (JP)

(72) Inventors: Naofumi INOMATA, Yokohama-shi (JP); Takeshi KAMBE, Yokohama-shi (JP)

(73) Assignee: Honda elesys Co., Ltd., Yokohama-shi (JP)

(21) Appl. No.: 13/856,196

(22) Filed: Apr. 3, 2013

(30) Foreign Application Priority Data
Apr. 3, 2012 (JP) 2012-084803

(51) Int. Cl. G01S 13/93

(52) U.S. Cl. CPC G01S 13/931
USPC 342/70

(57) ABSTRACT

A radar apparatus includes a transmitting antenna, a triangular wave generating unit that generates a first modulated wave and a second modulated wave which are transmitted from the transmitting antenna at a predetermined interval, a receiving antenna that receives radio waves obtained by causing an object to reflect the transmitted first and second modulated waves, and a signal intensity calculating unit that makes a determination, on peaks equal to or greater than a predetermined value appearing in received signals which are received by the receiving antenna and which correspond to the first and second modulated waves, as to whether the peaks are due to a signal obtained by causing the object to reflect the transmitted wave emitted from a host radar device or the peaks are due to a signal obtained by causing a reflecting object including the object to reflect the transmitted wave emitted from another radar device.

### CROSS-REFERENCE TO RELATED APPLICATIONS

Priority is claimed on Japanese Patent Application No. 2012-084803, filed Apr. 3, 2012, the contents of which are entirely incorporated herein by reference.

### BACKGROUND OF THE INVENTION

1. Field of the Invention

The present invention relates to a radar apparatus, an on-board radar system, and a program.

2. Description of Related Art

Recently, demands for a safety support system of vehicles have increased. On-board millimeter wave radars (hereinafter, referred to as radars) have decreased in cost and the number of radar-mounted vehicles has increased. A system in which a plurality of radars is mounted on a single vehicle has been proposed. Electronic scanning radars such as an FM-CW (Frequency Modulated Continuous Wave) radar, a multi-frequency CW (Continuous Wave) radar, and a pulse radar have been widely used as the on-board radars.

FIGS. 6A, 6B, and 6C are conceptual diagrams illustrating a relationship between a vehicle having a radar mounted thereon and occurrence of an interference wave. FIG. 6A shows an example where two vehicles each of which has a radar mounted thereon face each other. FIG. 6B shows an example where two vehicles each of which has a radar mounted thereon run side by side. FIG. 6C shows an example where a single vehicle has a plurality of radars mounted thereon.

In the examples shown in FIGS. 6A to 6C, a transmitted wave from a radar A1 is received by a radar A2. In the drawings, the radio waves when the radar A2 receives a transmitted wave from the radar A1 and a reflected wave based on the transmitted wave from the radar A1 are called interference waves. The interference waves may cause erroneous detection in the radar A2 depending on the receiving timings, and a speed control system using a radar may perform a deceleration control even when an obstacle is present on the front side but distance sufficient in traveling is secured. Accordingly, an uncomfortable feeling may be given to a user. When a following vehicle is present, the smooth traveling of the following vehicle may be hindered by the deceleration control.

An erroneous detection mechanism due to an interference wave will be described below in an FM-CW radar.

Part (a) and part (b) of FIG. 7 are conceptual diagrams illustrating an obstacle detection mechanism of an FM-CW type when there is no interference wave. As shown in part (a) of FIG. 7, a radar transmits a modulated signal (transmitted signal), receives a radio wave (received signal) reflected and returned from an object, and mixes the transmitted signal and the delayed received signal to convert the mixed signal into a frequency difference component, and calculates the distance to the object and the relative speed with respect to the object.

In part (b) of FIG. 7, a frequency difference fu of an ascending modulated portion of the transmitted signal and a frequency difference fd of a descending modulated portion thereof are shown by frequency-analyzing the frequency difference. An FM-CW radar combines (referred to as pairing) the frequency difference fu and the frequency difference fd and calculates the relative distance and the relative speed with respect to the object. Detection of a relative speed using the Doppler shift will not be described.

On the other hand, part (a) and part (b) of FIG. 8 are conceptual diagrams illustrating an obstacle detection mechanism of an FM-CW type when there is an interference wave. When an interference wave is interposed between a transmitted signal and a received signal as shown in part (a) of FIG. 8, an imaginary image due to the interference wave appears to correspond to a position within distance smaller than a received wave component as shown in part (b) of FIG. 8. Accordingly, a speed control system may perform an erroneous deceleration control based on the imaginary image due to the interference wave.

Therefore, a technique of removing an interference wave has been proposed.

(1) A cross-polarized wave is used

An obliquely-polarized wave is generally used. By arranging the polarization plane obliquely (mainly at 45 degrees) instead of horizontally or vertically, the polarization planes are crossed and it is thus possible to reduce an influence of the interference wave even when a radio wave is received from a radar in an opposing state.

(2) An interference state is detected and a modulation band and a modulation cycle are changed

For example, JP-A-2002-168947 (Patent Document 1) discloses a method of changing a frequency band of a transmitted signal or a frequency modulation cycle so as to avoid interference when the interference is detected.

### SUMMARY OF THE INVENTION

However, even when the obliquely-polarized wave is used, it is effective only in the opposite-direction state as shown in FIG. 6A, and it is not greatly effective in the same-direction state as shown in FIGS. 6B and 6C. A circularly-polarized wave can be used as the polarized wave, but causes a complicated structure, thereby causing a problem of an increase in cost and an increase in size.

In the technique described in Patent Document 1, when the frequency band or the modulation cycle of a transmitted wave is changed, there is a problem in that the resolution of a relative distance or a relative speed is changed, which affects subsequent processes of which parameters are set depending on the resolution. Since the transmitted signal is changed after interference is detected, there is a problem in that an interference state occurs until the interference is detected and thus a period in which an imaginary image due to the interference wave is output is present.

The present invention is made in consideration of the above-mentioned circumstances and an object thereof is to provide a radar apparatus, an on-board radar system, and a program which can determine whether a peak is an imaginary image due to an interference wave within a short time.

According to an aspect of the present invention, there is provided a radar apparatus including: a transmitting antenna; a triangular wave generating unit configured to generate a first modulated wave and a second modulated wave which are transmitted from the transmitting antenna at a predetermined interval; a receiving antenna that receives radio waves obtained by causing an object to reflect the transmitted first and second modulated waves; and a signal intensity calculating unit configured to make a determination, on peaks equal to or greater than a predetermined value appearing in received signals which are received by the receiving antenna and which correspond to the first and second modulated waves, as to whether the peaks are due to a signal obtained by causing the object to reflect the transmitted wave emitted from a host radar device or the peaks are due to a signal obtained by causing a reflecting object including the object to reflect the transmitted wave emitted from another radar device.

In the radar apparatus, the signal intensity calculating unit may determine whether the peaks are due to a signal obtained by causing the object to reflect the transmitted wave emitted from the host radar device or the peaks are due to a signal obtained by causing a reflecting object including the object to reflect the transmitted wave emitted from another radar device based on distances to the object, which are indicated by the peak equal to or greater than a predetermined value appearing in the received signal corresponding to the first modulated wave and the peak equal to or greater than a predetermined value appearing in the received signal corresponding to the second modulated wave.

In the radar apparatus, the signal intensity calculating unit may determine whether the peaks are due to a signal obtained by causing the object to reflect the transmitted wave emitted from the radar apparatus or the peaks are due to a signal obtained by causing a reflecting object including the object to reflect the transmitted wave emitted from another radar device based on a distance to the object and a relative speed with respect to the object, which are indicated by the peak equal to or greater than a predetermined value appearing in the received signal corresponding to the first modulated wave and the peak equal to or greater than a predetermined value appearing in the received signal corresponding to the second modulated wave.

In the radar apparatus, the signal intensity calculating unit may transform the received signals corresponding to the first and second modulated waves to a frequency spectrum, and the signal intensity calculating unit may compare a frequency of the peak equal to or greater than a predetermined value appearing in the received signal corresponding to the first modulated wave and a frequency of the peak equal to or greater than a predetermined value appearing in the received signal corresponding to the second modulated wave, may determine that the received signals are signals obtained by causing the object to reflect the transmitted waves emitted by the host radar device when the frequencies are values corresponding to the same distance, and may determine that the received signals are signals obtained by causing a reflecting object including the object to reflect the transmitted waves emitted from another radar device when the frequencies are values not corresponding to the same distance.

In the radar apparatus, the signal intensity calculating unit may transform the received signals corresponding to the first and second modulated waves to a frequency spectrum, and the signal intensity calculating unit may compare a frequency of the peak equal to or greater than a predetermined value appearing in the received signal corresponding to the first modulated wave and a frequency of the peak equal to or greater than a predetermined value appearing in the received signal corresponding to the second modulated wave, may determine that the received signals are signals obtained by causing the object to reflect the transmitted waves emitted by the host radar device when the frequencies are values corresponding to the same distance and the same relative speed, and may determine that the received signals are signals obtained by causing a reflecting object including the object to reflect the transmitted waves emitted from another radar device when the frequencies are values not corresponding to the same distance and the same relative speed.

In the radar apparatus, the first modulated wave and the second modulated wave may be transmitted signals which are swept with preset modulation widths for preset sweep times with respect to preset central frequencies.

In the radar apparatus, the triangular wave generating unit may change the interval of at least one of the first modulated wave and the second modulated wave.

In the radar apparatus, the triangular wave generating unit may determine the interval of at least one of the first modulated wave and the second modulated wave by a random number.

In the radar apparatus, the triangular wave generating unit may determine the interval of at least one of the first modulated wave and the second modulated wave based on an output having a deviation output from hardware constituting the radar apparatus or based on a calculation result using the output value of the hardware.

According to another aspect of the present invention, there is provided an on-board radar system including a plurality of radar apparatuses mounted on the front side of a vehicle, wherein each of the plurality of radar apparatuses includes: a transmitting antenna; a triangular wave generating unit configured to generate a first modulated wave and a second modulated wave which are transmitted from the transmitting antenna at a predetermined interval; a receiving antenna that receives radio waves obtained by causing an object to reflect the transmitted first and second modulated waves; and a signal intensity calculating unit configured to make a determination, on peaks equal to or greater than a predetermined value appearing in received signals which are received by the receiving antenna and which correspond to the first and second modulated waves, as to whether the peaks are due to a signal obtained by causing the object to reflect the transmitted wave emitted from a host radar device or the peaks are due to a signal obtained by causing a reflecting object including the object to reflect the transmitted wave emitted from another radar device.

In the on-board radar system, each of the plurality of radar apparatuses may transmit the first modulated wave and the second modulated wave, which are swept with preset modulation widths for preset sweep times with respect to preset central frequencies, from the transmitting antenna at different intervals.

In the on-board radar system, the signal intensity calculating unit may transform the received signals corresponding to the first and second modulated waves to a frequency spectrum, and the signal intensity calculating unit may compare a frequency of the peak equal to or greater than a predetermined value appearing in the received signal corresponding to the first modulated wave and a frequency of the peak equal to or greater than a predetermined value appearing in the received signal corresponding to the second modulated wave, may determines that the received signals are signals obtained by causing the object to reflect the transmitted waves emitted by the host radar device when the frequencies are values corresponding to the same distance, and may determine that the received signals are signals obtained by causing a reflecting object including the object to reflect the transmitted waves emitted from another radar device when the frequencies are values not corresponding to the same distance.

In the on-board radar system, the signal intensity calculating unit may transform the received signals corresponding to the first and second modulated waves to a frequency spectrum, and the signal intensity calculating unit may compare a frequency of the peak equal to or greater than a predetermined value appearing in the received signal corresponding to the first modulated wave and a frequency of the peak equal to or greater than a predetermined value appearing in the received signal corresponding to the second modulated wave, may determine that the received signals are signals obtained by causing the object to reflect the transmitted waves emitted by the host radar device when the frequencies are values corresponding to the same distance and the same relative speed, and may determine that the received signals are signals obtained by causing a reflecting object including the object to reflect the transmitted waves emitted from another radar device when the frequencies are values not corresponding to the same distance and the same relative speed.

The on-board radar system may further include a control unit configured to perform at least one of giving of an alarm notifying that an obstacle is present and a control of speed when the signal intensity calculating unit determines that the received signals are signals obtained by causing the object to reflect the transmitted waves emitted from the host radar device and configured not to perform giving of the alarm and the control of speed when the signal intensity calculating unit determines that the received signals are signals obtained by causing a reflecting object including the object to reflect transmitted waves emitted from another radar device.

According to another aspect of the present invention, there is provided a program causing a computer to perform: transmitting a first modulated wave and a second modulated wave at a predetermined interval from a transmitting antenna; and making a determination, on peaks equal to or greater than a predetermined value appearing in received signals which are received by the receiving antenna and which correspond to the first and second modulated waves, as to whether the peaks are due to a signal obtained by causing the object to reflect the transmitted wave emitted from a host radar device or the peaks are due to a signal obtained by causing a reflecting object including the object to reflect the transmitted wave emitted from another radar device.

According to the various aspects of the present invention, it is possible to determine whether a peak is an imaginary image due to an interference wave within a short time.

### BRIEF DESCRIPTION OF THE DRAWINGS

FIG. 1 is a block diagram illustrating a configuration of a radar apparatus according to an embodiment of the present invention.

FIG. 2 is a conceptual diagram illustrating an on-board radar system using the radar apparatus according to the embodiment.

FIG. 3 is a conceptual diagram illustrating an obstacle detection mechanism of the radar apparatus according to the embodiment.

FIG. 4 is a flowchart illustrating operations of radar apparatuses A1 and A2 according to the embodiment.

FIG. 5 is a flowchart illustrating a peak detecting operation (step S16) in a received intensity calculator according to the embodiment.

FIGS. 6A to 6C are conceptual diagrams illustrating a relationship between a vehicle having a radar mounted thereon and occurrence of an interference wave.

FIG. 7 is a conceptual diagram illustrating an obstacle detection mechanism of an FM-CW type when there is no interference wave.

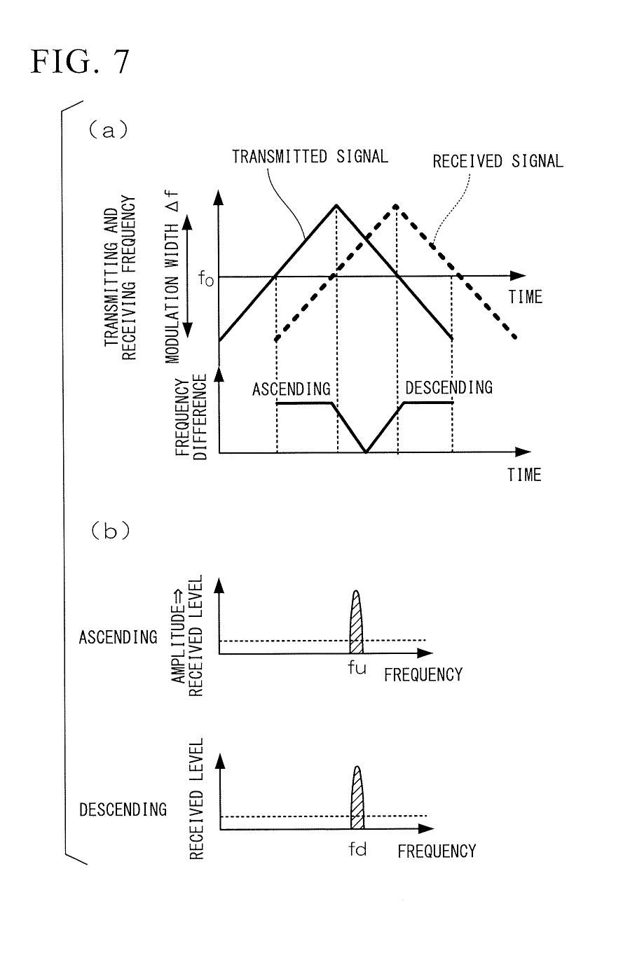

FIG. 8 is a conceptual diagram illustrating an obstacle detection mechanism of an FM-CW type when there is an interference wave.

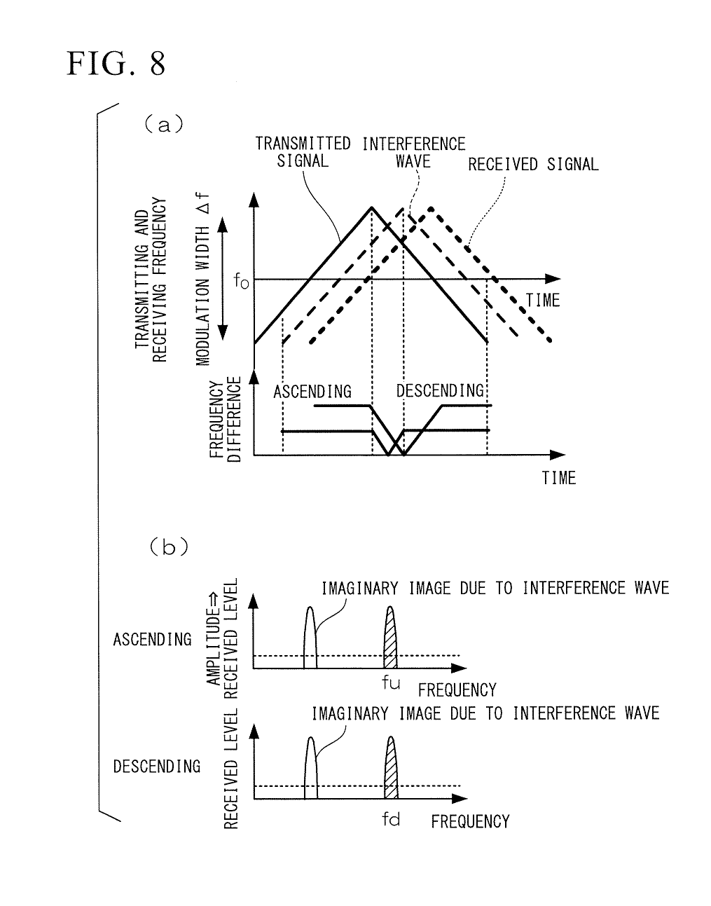

### DETAILED DESCRIPTION OF THE INVENTION

Hereinafter, an embodiment of the present invention will be described with reference to the accompanying drawings.

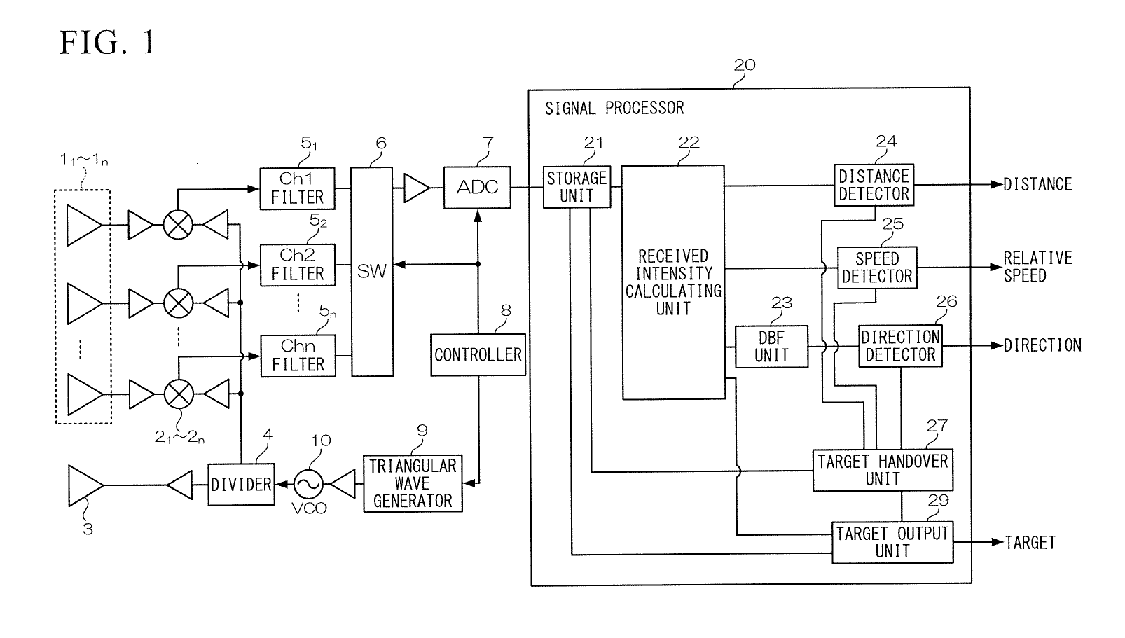

FIG. 1 is a block diagram illustrating a configuration of a radar apparatus according to an embodiment of the present invention. In FIG. 1, a radar apparatus includes receiving antennas 1₁ to 1ₙ (where n is a positive integer), mixers 2₁ to 2ₙ (where n is a positive integer), a transmitting antenna 3, a divider 4, filters 5₁ to 5ₙ (where n is a positive integer), a SW (switch) 6, an ADC (A/D converter, received wave acquiring unit) 7, a controller 8, a triangular wave generator 9, a VCO (Voltage-Controlled Oscillator) 10, and a signal process 20. In the configuration shown in FIG. 1, one transmitting antenna 3 and a plurality of receiving antennas 1₁ to 1ₙ is used; however, the present invention is not limited to this configuration. A combination of one transmitting antenna and one receiving antenna, a combination of one transmitting antenna and a plurality of receiving antennas, a combination of a plurality of transmitting antennas and one receiving antenna, or a combination of a plurality of transmitting antennas and a plurality of receiving antennas may be employed. The receiving antenna and the transmitting antenna may be shared or may be switched in a time division manner.

The signal processor 20 includes a storage unit 21, a received intensity calculator (signal intensity calculating unit) 22, a DBF unit 23, a distance detector 24, a speed detector 25, a direction detector 26, a target handover unit 27, and a target output unit 29.

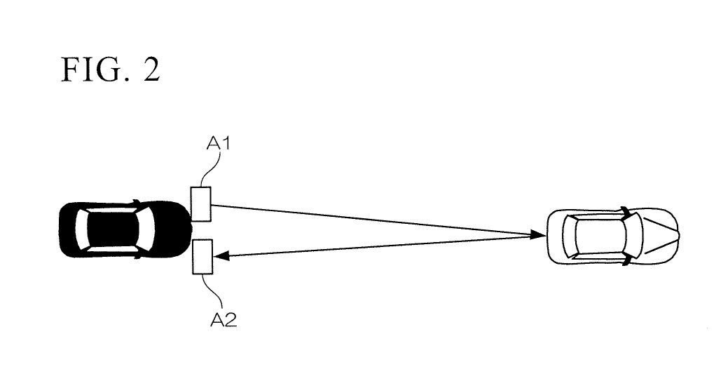

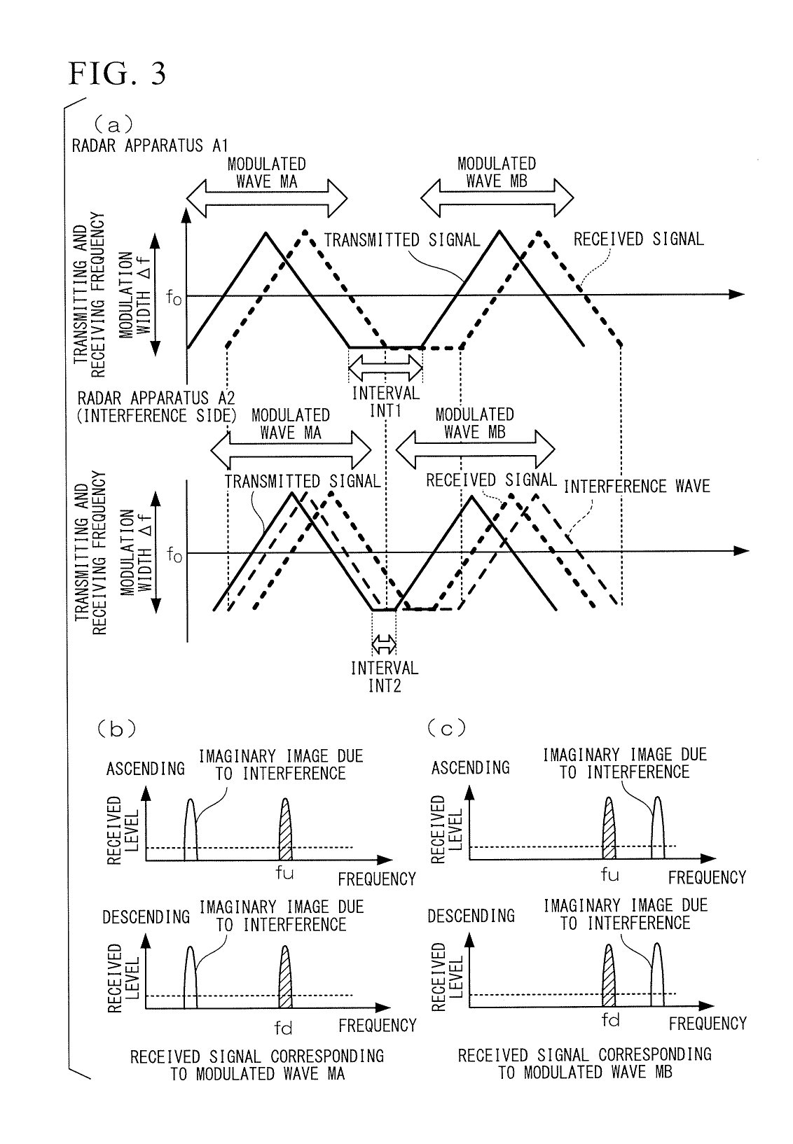

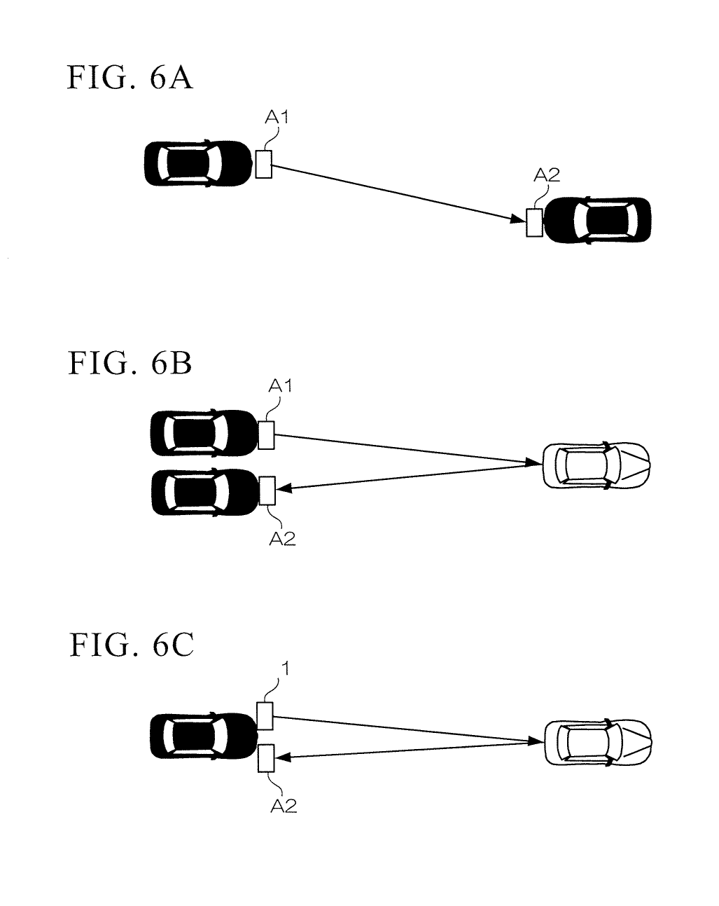

FIG. 2 is a conceptual diagram illustrating an on-board radar system using the radar apparatus according to the embodiment. Part (a), part (b), and part (c) of FIG. 3 are conceptual diagrams illustrating an obstacle detection mechanism of the radar apparatus according to the embodiment. As shown in FIG. 2, this embodiment describes an example where a transmitted wave from one radar apparatus A1 is received by the other radar apparatus A2 when two radar apparatuses A1 and A2 are mounted on a vehicle (and vice versa). That is, this example corresponds to the example shown in FIG. 6C.

As shown in part (a) of FIG. 3, the radar apparatus A1 transmits a modulated wave MA and a modulated wave MB as a transmitted signal with a predetermined interval INT1 interposed therebetween. Similarly, as shown in part (a) of FIG. 3, the radar apparatus A2 transmits a modulated wave MA and a modulated wave MB as a transmitted signal with a predetermined interval INT2 interposed therebetween. It is assumed that the intervals INT1 and INT2 in the radar apparatus A1 and the radar apparatus A2 are different from each other. The modulated wave MA and the modulated wave MB are swept with a modulation width Δf for preset sweep times with respect to the central frequency f₀. Here, the central frequency f₀, the sweep time (modulation wave width), the modulation width Δf can be independently set for each of the modulated waves MA and MB. The modulated wave MA and the modulated wave MB may have the same period or may have different periods.

For example, when the transmitted signal of the radar apparatus A1 is reflected by an object and is received by the radar apparatus A1, a frequency difference corresponding to the same delay is present between the modulated wave MA and the modulated wave MB. The same is true of the radar apparatus A2.

On the contrary, when the transmitted signal of the radar apparatus A1 is reflected by an object and is received as an interference wave by the radar apparatus A2, the interference wave is marked by a dotted line in part (a) of FIG. 3. In this case, in the modulated wave MA, an imaginary image appears at a position closer (on the lower frequency side) than the object due to the interference wave, as shown in part (b) of FIG. 3. On the other hand, in the modulated wave MB, an imaginary image appears at a position farther (on the higher frequency side) than the object, as shown in part (c) of FIG. 3. The imaginary images may appear on the same sides (on the closer side or the farther side for both the modulated wave MA and the modulated wave MB), but are output at different frequencies in this case.

Peaks fu and fd of an actual object represent the same distance and the same relative speed (the same frequency) (depending on the relationship between the frequency and the distance), but the interference wave represents different distances and different relative speeds (different frequencies) as described above. Therefore, by comparing the positions (frequencies) of the peaks detected in the ascending and descending portions in the modulated wave MA and the modulated wave MB, the peak at which both do not match is determined to be an imaginary image due to the interference wave. In other words, when the peak positions match each other, the peaks can be determined as the peaks fu and fd based on the actual object. In this way, by setting the intervals INT1 and INT2 to be different from each other using two modulated waves MA and MB from two radar apparatuses A1 and A2, it is possible to determine the presence of an interference wave.

It is described above that the transmitted signal from the radar apparatus A1 is received by the radar apparatus A2, but the same is true of a case where the transmitted signal from the radar apparatus A2 is received by the radar apparatus A1. In this way, this method provides the method of removing an interference wave from a target output of the radar apparatus using two modulated waves instead of suppressing interference between antennas due to polarized waves or the like.

The following techniques of setting the intervals INT1 and INT2 of the modulated waves MA and MB to be different from each other can be considered.
(a) The interval is dynamically changed for each constant cycle.
(b) The interval is set to a value unique to each radar apparatus.
(c) A plurality of interval tables is prepared and is assigned to the radar apparatuses A1 and A2.
(d) A random value is prepared using the remainder when the sum of ADC output values is calculated and is divided by a desired resolution.
(e) A random value is prepared using the remainder when the sum of point values of the FFT result is calculated and is divided by a desired resolution
(f) The interval is changed for each cycle using a random function of a CPU. Operations of the radar apparatuses A1 and A2 according to the present invention will be described below with reference to FIG. 1.

The receiving antennas 1₁ to 1ₙ receive a received wave, that is, a received signal, which is obtained by causing an object to reflect the transmitted signal and which arrives from the object. Each of the mixers 2₁ to 2ₙ mixes the transmitted signal transmitted from the transmitting antenna 3 and a signal obtained by amplifying the received signal received by each of the receiving antennas 1₁ to 1ₙ through the use of an amplifier and generates beat signals.

The transmitting antenna 3 transmits transmitted signals (modulated waves MA and MB), which are obtained by frequency-modulating a triangular signal generated by the triangular wave generator 9 through the use of the VCO 10, as a transmitted wave with predetermined intervals INT1 and INT2 to an object.

The divider 4 divides the transmitted signals frequency-modulated by the VCO 10 to the mixers 2₁ to 2ₙ and the transmitting antenna 3.

The filters 5₁ to 5ₙ band-limit the beat signals of Ch1 to Chn corresponding to the receiving antennas 1₁ to 1ₙ and generated by the mixers 2₁ to 2ₙ and supply the band-limited beat signals to the SW (switch) 6.

The SW 6 sequentially supplies the beat signals of Ch1 to Chn corresponding to the receiving antennas 1₁ to 1ₙ and passing through the filters 5₁ to 5ₙ to the ADC 7 in response to a sampling signal input from the controller 8.

The ADC 7 converts the beat signals of Ch1 to Chn, which correspond to the receiving antennas 1₁ to 1ₙ and are input from the SW 6 in synchronization with the sampling signal, into digital signals in the A/D (analog-to- digital) conversion manner at a predetermined sampling frequency in synchronization with the sampling signal, and sequentially stores the converted digital signals in a waveform storage area of the storage unit 21 of the signal processor 20. In other words, the ADC 7 acquires the beat signals at a predetermined time interval.

The controller 8 is constructed by a microcomputer or the like and controls the entire radar apparatus based on a control program stored in a ROM (not shown) or the like.

The storage unit 21 of the signal processor 20 stores the digital signals digital-converted by the ADC 7 for each channel corresponding to the receiving antennas 1₁ to 1ₙ.

The received intensity calculator 22 performs a Fourier transformation on the beat signal for each channel corresponding to the receiving antennas 1₁ to 1ₙ and stored in the storage unit 21. Here, the amplitude of complex data after the Fourier transformation is called a signal level.

The received intensity calculating unit 22 can detect presence of an object depending on beat frequencies (that is, distances) corresponding to the peak values of a spectrum by transforming complex data of any one antenna or the sum of complex data of the overall antennas to a frequency spectrum. Here, when the received intensity calculator 22 uses the sum of complex data of the overall antennas, the noise components are averaged to improve the S/N ratio by the summation of complex data of the overall antennas.

The received intensity calculator 22 determines whether an object is present, by detecting a signal level greater than a predetermined value (threshold value) from the signal level for each beat frequency shown in part (b) and part (c) of FIG. 3. Here, the peak value of the signal level is called the intensity of a received wave.

When a peak of an object is detected, the received intensity calculator 22 supplies the beat frequencies of the peak value (both of the ascending region and the descending region of the beat signal) as object frequencies fu and fd to the distance detector 24 and the speed detector 25. The received intensity calculator 22 supplies the frequency modulation width Δf to the distance detector 24 and supplies the central frequency f₀ to the speed detector 25.

When a peak of a signal level is not detected, the received intensity calculator 22 supplies information indicating that an object is not present to the target output unit 29.

The average of the peak value of the ascending portion of a beat signal or the peak value of the ascending region of the beat signal and the peak value of the descending region of the beat signal may be used as the signal level.

Then, the distance detector 24 calculates distance R using Equation (1) based on the object frequency fu of the ascending portion and the object frequency fd of the descending portion which are input from the received intensity calculator 22.

R=(c·T/(2·Δf))·((fu+fd)/2) (1)

Here, c represents the light speed and T represents the modulation time (ascending portion/descending portion).

The distance detector 24 supplies information indicating the calculated distance

R to the object to the target handover unit 27 and an external device not shown. The distance detector 24 stores the information indicating the distance R to the object in the storage unit 21.

The speed detector 25 calculates a relative speed V using Equation (2) based on the object frequency fu of the ascending portion and the object frequency fd of the descending portion which are input from the received intensity calculator 22, and supplies information indicating the calculated relative speed V with respect to the target handover unit 27 and an external device not shown.

V=(c/(2·f₀))·((fu−fd)/2) (2)

The DBF (Digital Beam Forming) unit 23 performs a Fourier transformation, that is, a spatial-axis Fourier transformation, on the input complex data Fourier-transformed to the time axis and corresponding to the antennas using the phase difference of the received waves received by the receiving antennas. The DBF unit 23 calculates a function of received radio wave intensity (received intensity) indicating the intensity of a spectrum for each angle channel corresponding to an angle resolution, and supplies information indicating that the calculated function of received intensity to the direction detector 26.

The direction detector 26 sets the angle φ having the largest value out of the calculated values of the function of received intensity for each angle channel as an object direction and supplies information indicating the object direction to the target handover unit 27 and an external device not shown. The direction detecting unit 26 stores the information indicating the object direction in the storage unit 21.

The target handover unit 27 determines that an object detected in the previous cycle and the object detected in the present cycle are the same, when the absolute values of differences between the values of the distance to an object, the relative speed, and the direction calculated in the present cycle and the values of the distance to an object, the relative speed, and the direction calculated in the previous cycle and read from the storage unit 21 are smaller than threshold values set for the values.

In this case, the target handover unit 27 increases the target handover number of the object read from the storage unit 21 by 1. Otherwise, the target handover unit 27 considers that a new object is detected. The target handover unit 27 stores information indicating the distance to the object of the present cycle, information indicating the relative speed, information indicating the direction, and information indicating the target handover number of the object in the storage unit 21.

The target output unit 29 extracts an object in the same lane of the vehicle from the direction of the object and supplies information indicating an identification number of the object in the same lane as the vehicle to an external device not shown as a target.

Accordingly, when the object is a normal detection object having a risk of collision, the external device can decelerate the vehicle to avoid collision or can give an alarm to the driver.

When two or more objects are present in the same lane as the vehicle, the target output unit 29 supplies the identification number of the object having a larger target handover number read from the storage unit 21 to an external device not shown as a target. When information indicating that an object is not present is input from the received intensity calculator 22, the target output unit 29 supplies information indicating that a target is not present to an external device not shown.

### Principles of Detecting Distance, Relative Speed, Horizontal Angle (Direction), and Interference Wave

Principles of detecting the distance between a radar apparatus and an object, the relative speed, the angle (direction), and the interference wave which are used in the signal processor 20 will be described below in brief with reference to FIG. 3.

FIG. 3 is a conceptual diagram illustrating generation of a beat signal in an ascending region and a descending region of a triangular wave based on the transmitted signal and the received signal using two modulated signals MA and MB. In part (a) of FIG. 3, the transmitted signal obtained by frequency-modulating the signal generated by the triangular wave generator 9 shown in FIG. 1 at a predetermined interval INT1 (INT2) using two modulated waves MA and MB with a central frequency f₀ and a modulation width Δf through the use of the VCO 10 in the radar apparatus A1 and the received signal obtained by causing an object to reflect the transmitted signal in the radar apparatus A2 are shown. In the example shown in part (a) to part (c) of FIG. 3, the number of objects is one.

As shown in part (a) of FIG. 3, the received signal which is a reflected wave obtained by causing an object to reflect the transmitted signal is received with a delay to the right (in the time delay direction) depending on the distance between the radar apparatus and the object. Although not shown in the drawing, the received signal actually varies in the up-down direction (in the frequency direction) with respect to the transmitted signal depending on the relative speed with respect to the object due to the Doppler effect.

When a plurality of objects is present, the same number of peaks as the number of objects appear in the ascending portion of a beat signal and the descending portion of a beat signal after the Fourier transformation, as shown in part (b) and part (c) of FIG. 3. Since the received signal from the radar apparatus A1 is received, a peak as an imaginary image due to an interference wave appears. The received signal is delayed in proportion to the distance between the radar apparatus and the object and the received signal shown in part (a) of FIG. 3 is shifted to the right. Accordingly, as the distance between the radar apparatus and the object becomes larger, the frequency of the beat signal in part (b) and part (c) of FIG. 3 becomes higher.

When a plurality of peaks of the signal levels corresponding to a plurality of objects is detected, the received intensity calculator 22 sequentially numbers the peak values of the ascending portion and the descending portion from the smallest frequency, and supplies the numbered peak values to the target output unit 29. Here, the peak having the same number in the ascending and descending portions corresponds to the same object and the identification numbers thereof are used as the object number.

As described above, the radar apparatus A1 transmits the modulated wave MA and the modulated wave MB as a transmitted signal with a predetermined interval INT1 interposed therebetween, as shown in part (a) of FIG. 3. Similarly, the radar apparatus A2 transmits the modulated wave MA and the modulated wave MB as a transmitted signal with a predetermined interval INT2, which is different from the interval INT1, interposed therebetween, as shown in part (a) of FIG. 3.

As the Fourier transformation result in the received intensity calculator 22, when one object is present as shown in part (b) and part (c) of FIG. 3, peaks fu and fd appear in the ascending portion and the descending portion, respectively. In part (b) and part (c) of FIG. 3, the horizontal axis represents the frequency and the vertical axis represents the signal intensity. However, when the transmitted signal of the radar apparatus A1 is reflected by an object and is received as an interference wave by the radar apparatus A2, an imaginary image appears at a position closer (on the lower frequency side) than the object in the received signal in response to the modulated wave MA due to the interference wave in the radar apparatus A2, as shown in part (b) of FIG. 3. On the other hand, in the received signal corresponding to the modulated wave MB, an imaginary image appears at a position farther (on the higher frequency side) than the object, as shown in part (c) of FIG. 3.

The object frequencies fu and fd based on the peaks of an object represent the same distance (the same frequency) (depending on the relationship between the frequency and the distance) in both the modulated waves MA and MB, but the imaginary image due to the interference wave represents different distances (different frequencies) in the modulated waves MA and MB. Therefore, by comparing the peak positions (frequencies) detected in the ascending region and the descending region of the received signals corresponding to the modulated waves MA and MB, it is determined that peaks do not match each other is an imaginary image due to an interference and peaks match each other is due to an object.

That is, the received intensity calculator 22 sequentially compares the peak positions (frequencies) in the ascending region and the descending region of the received signals corresponding to the modulated wave MA and the modulated wave MB, and supplies the peaks fu and fd of the object as the object frequencies fu and fd to the distance detector 24 and the speed detector 25, supplies the frequency modulation width Δf to the distance detector 24, and supplies the central frequency f₀ to the speed detector 25, when both match each other. On the other hand, the received intensity calculator 22 supplies information indicating that an object is not present to the target output unit 29, when a peak or peaks match each other are not detected.

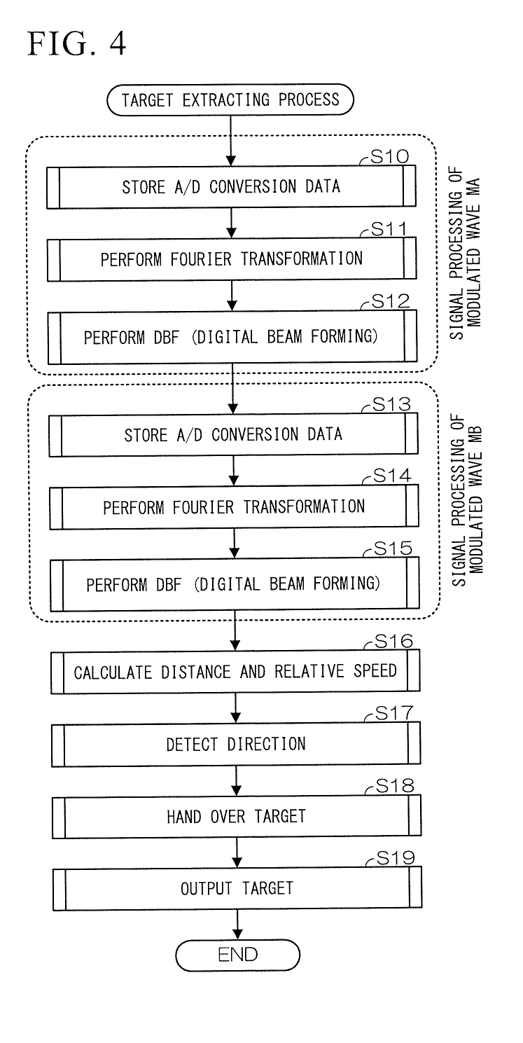

FIG. 4 is a flowchart illustrating operations of the radar apparatuses A1 and A2 according to the embodiment. The receiving operation of the radar apparatus A2 will be described below, but the same is true of the radar apparatus A1.

First, the ADC 7 stores A/D conversion data to which the beat signal corresponding to the modulated wave MA is converted in the A/D conversion manner in the storage unit 21 (step S 10). Then, the received intensity calculator 22 reads the A/D conversion data corresponding to the modulated wave MA from the storage unit 21 and calculates the received intensity for each frequency by Fourier-transforming the read A/D conversion data (step S11). Subsequently, The DBF unit 23 calculates the relationship between the received intensity for each channel and the relative distance by DBF-processing on the received intensity for each frequency corresponding to the modulated wave MA and calculated by the received intensity calculator 22 (step S12).

Then, the ADC 7 stores A/D conversion data to which the beat signal corresponding to the modulated wave MB is converted in the A/D conversion manner in the storage unit 21 (step S13). Then, the received intensity calculator 22 reads the A/D conversion data corresponding to the modulated wave MB from the storage unit 21 and calculates the received intensity for each frequency by Fourier-transforming the read A/D conversion data (step S14). Subsequently, The DBF unit 23 calculates the relationship between the received intensity for each channel and the relative distance by DBF-processing on the received intensity for each frequency corresponding to the modulated wave MB and calculated by the received intensity calculator 22 (step S15).

Then, the received intensity calculator 22, the distance detector 24, and the speed detector 25 detect peaks based on the reflected wave from an object while excluding an imaginary image due to the interference wave, and calculate the distance to the object and the relative speed with respect to the object based on the peaks (step S 16). At this time, as described above, the received intensity calculator 22 sequentially compares the peak positions (frequencies) in the ascending region and the descending region of the received signals corresponding to the modulated wave MA and the modulated wave MB, and supplies information indicating that an object is not present to the target output unit 29 when peaks matched in both are not detected. On the other hand, when peaks matched in both are detected, the received intensity calculator 22 supplies the peaks fu and fd of the object as the object frequencies fu and fd to the distance detector 24 and the speed detector 25, supplies the frequency modulation width Δf to the distance detector 24, and supplies the central frequency fₒ to the speed detector 25. The distance detector 24 calculates the relative distance to the object based on the object frequencies fu and fd and the frequency modulation width Δf, and the speed detector 25 calculates the relative speed with respect to the object based on the object frequencies fu and fd and the central frequency f₀. The direction detector 26 calculates the direction of the object (step S 17).

The target output unit 29 correlates the object extracted in the present cycle with the target until the previous cycle (step S18). Then, the target output unit 29 extracts a higher-ranked target out of the objects and outputs the extracted target to the outside (step S19). Then, the flow of operations is ended.

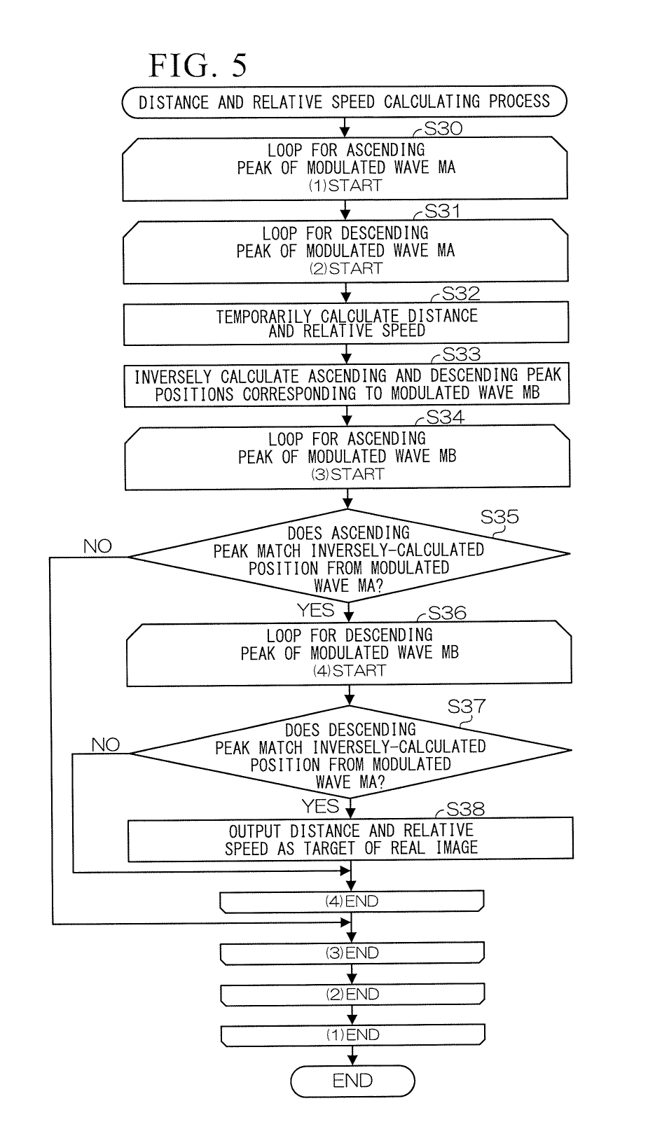

FIG. 5 is a flowchart illustrating operations (step S16) of a distance and relative speed calculating process in the received intensity calculator 22, the distance detector 24, and the speed detector 25 according to this embodiment. The received intensity calculator 22 starts a loop for an ascending peak of the modulated wave MA (step S30) to detect a peak while changing the frequencies from a low frequency to a high frequency in the ascending region of the modulated wave MA, and then starts a loop for a descending peak of the modulated wave MA (step S31).

Then, the distance detector 24 and the speed detector 25 temporarily calculate the distance and the relative speed (step S32) and inversely calculate the ascending and descending peak positions corresponding to the modulated wave MB (step S33). Subsequently, a loop for an ascending peak of the modulated wave MB is started (step S34). In the loop for the ascending peak of the modulated wave MB, it is determined whether the peak in the ascending region of the modulated wave MB matches the inversely-calculated position from the modulated wave MA, that is, whether a peak is present at the same position in the ascending region of the modulated wave MA (step S35). When the peaks are not matched, that is, when a peak is not present at the same position in the ascending region of the modulated wave MA (NO in step S35), the comparison is sequentially repeated on next peaks in the ascending region of the modulated wave MB by repeating the loop.

On the other hand, when both peaks are matched, that is, when a peak is present at the same position in the ascending region of the modulated wave MA (YES in step S35), a loop for a descending peak of the modulated wave MB is started (step S36). In the loop for the descending peak of the modulated wave MB, it is determined whether a peak position in the descending region of the modulated wave MB matches the inversely-calculated position from the modulated wave MA, that is, whether a peak is present at the same position in the descending region of the modulated wave MA (step S37). When the peaks are not matched, that is, when a peak is not present at the same position in the descending region of the modulated wave MA (NO in step S37), the comparison is sequentially repeated on next peaks in the descending region of the modulated wave MB by repeating the loop.

On the other hand, when both peaks are matched, that is, when a peak is present at the same position in the descending region of the modulated wave MB (YES in step S37), the distance detector 24 calculates and outputs the relative distance to the object based on the object frequency fu and fd and the frequency modulation width Δf corresponding to the peak, and the speed detector 25 calculates and outputs the relative speed with respect to the object based on the object frequency fu and fd and the central frequency f₀ corresponding to the peak (step S38).

According to the process of calculating the distance and the relative speed, the distance and the relative speed are not output when the peak appearing in the ascending or descending region of the modulated wave MB does not appear at the same position (frequency) in the ascending or descending region of the modulated wave MA, that is, when the peak positions (frequencies) do not match each other, and the distance and the relative speed are output when the peak appearing in the ascending or descending region of the modulated wave MB appears at the same position (frequency) in the ascending or descending region of the modulated wave MA, that is, when the peak positions (frequencies) match each other.

According to the above-mentioned embodiment, it is possible to determine whether a peak is an imaginary image due to an interference wave within a short time. Since an influence of an interference wave is immediately suppressed without causing a variation in resolution due to a variation in modulation specification, the present invention is very effective for on-board radar systems which have been spreading.

In this embodiment, an electronic scanning radar apparatus is described above as the radar apparatus, but the present invention is not limited to the embodiment. The present invention can be applied to a mechanical scanning radar apparatus.

In this embodiment, the signal processing of the modulated wave MA in steps S10 to S12 and the signal processing of the modulated wave MB in steps S13 to S15 shown in FIG. 4 are performed in series, but the present invention is not limited to the embodiment. They may be performed in parallel.

Only the radar apparatus is described above in the embodiment of the present invention; however, the on-board radar system may further include a controller that gives an alarm indicating that an obstacle is present or controls a speed based on the output signal (the distance, the relative speed, the direction, and the target) from the radar apparatus. In this case, the controller gives an alarm indicating that an obstacle is present or controls the speed when the signal intensity calculator 22 determines that the received signal is a signal obtained by causing the object to reflect a transmitted wave emitted from the corresponding radar apparatus, and does not give the alarm or does not control the speed when the signal intensity calculator 22 determines that the received signal is a signal obtained by causing a reflecting object including the object to reflect a transmitted wave emitted from a different radar apparatus, that is, when the received signal is an interference wave.

Furthermore, the function or a part of the function of the signal processor 20 in the embodiment of the present invention may be realized by a computer. In this case, a program for realizing the control function may be recorded on a computer-readable recording medium, and the program recorded on the recording medium may be read by a computer system for execution. Here, the “computer system” may include hardware such as an OS (Operation system) or peripherals. Furthermore, the “computer-readable recording medium” refers to a removable medium such as a flexible disk, a magneto-optical disc, a ROM or a CD-ROM, or a storage device such as a hard disk built in the computer system. Furthermore, the “computer-readable recording medium” may include a medium that dynamically stores a program for a short time, such as a communication cable in a case where the program is transmitted through a network such as the internet or a communication line such as a telephone line, or a medium that stores, in this case, the program for a specific time, such as a volatile memory inside a computer system including a server and a client. Furthermore, the program may be a program that realizes a part of the above-described functions, or may be a program that realizes the above-described functions by combination with a program that is recorded in advance in the computer system.

While preferred embodiments of the invention have been described and illustrated above, it should be understood that the invention is not to be considered as being limited by the foregoing embodiments, and includes designs and the like within the scope of the concept of the invention.

What is claimed is:

1. A radar apparatus comprising:
a transmitting antenna;
a triangular wave generating unit configured to generate a first modulated wave and a second modulated wave which are transmitted from the transmitting antenna at a predetermined interval;
a receiving antenna that receives radio waves obtained by causing an object to reflect the transmitted first and second modulated waves; and
a signal intensity calculating unit configured to make a determination, on peaks equal to or greater than a predetermined value appearing in received signals which are received by the receiving antenna and which correspond to the first and second modulated waves, as to whether the peaks are due to a signal obtained by causing the object to reflect the transmitted wave emitted from a host radar device or the peaks are due to a signal obtained by causing a reflecting object including the object to reflect the transmitted wave emitted from another radar device.

2. The radar apparatus according to claim 1, wherein the signal intensity calculating unit determines whether the peaks are due to a signal obtained by causing the object to reflect the transmitted wave emitted from the host radar device or the peaks are due to a signal obtained by causing a reflecting object including the object to reflect the transmitted wave emitted from another radar device based on distances to the object, which are indicated by the peak equal to or greater than a predetermined value appearing in the received signal corresponding to the first modulated wave and the peak equal to or greater than a predetermined value appearing in the received signal corresponding to the second modulated wave.

3. The radar apparatus according to claim 1, wherein the signal intensity calculating unit determines whether the peaks are due to a signal obtained by causing the object to reflect the transmitted wave emitted from the radar apparatus or the peaks are due to a signal obtained by causing a reflecting object including the object to reflect the transmitted wave emitted from another radar device based on a distance to the object and a relative speed with respect to the object, which are indicated by the peak equal to or greater than a predetermined value appearing in the received signal corresponding to the first modulated wave and the peak equal to or greater than a predetermined value appearing in the received signal corresponding to the second modulated wave.

4. The radar apparatus according to claim 2, wherein the signal intensity calculating unit transforms the received signals corresponding to the first and second modulated waves to a frequency spectrum, and
wherein the signal intensity calculating unit compares a frequency of the peak equal to or greater than a predetermined value appearing in the received signal corresponding to the first modulated wave and a frequency of the peak equal to or greater than a predetermined value appearing in the received signal corresponding to the second modulated wave, determines that the received signals are signals obtained by causing the object to reflect the transmitted waves emitted by the host radar device when the frequencies are values corresponding to the same distance, and determines that the received signals are signals obtained by causing a reflecting object including the object to reflect the transmitted waves emitted from another radar device when the frequencies are values not corresponding to the same distance.

5. The radar apparatus according to claim 3, wherein the signal intensity calculating unit transforms the received signals corresponding to the first and second modulated waves to a frequency spectrum, and
wherein the signal intensity calculating unit compares a frequency of the peak equal to or greater than a predetermined value appearing in the received signal corresponding to the first modulated wave and a frequency of the peak equal to or greater than a predetermined value appearing in the received signal corresponding to the second modulated wave, determines that the received signals are signals obtained by causing the object to reflect the transmitted waves emitted by the host radar device when the frequencies are values corresponding to the same distance and the same relative speed, and determines that the received signals are signals obtained by causing a reflecting object including the object to reflect the transmitted waves emitted from another radar device when the frequencies are values not corresponding to the same distance and the same relative speed.

6. The radar apparatus according to claim 1, wherein the first modulated wave and the second modulated wave are transmitted signals which are swept with preset modulation widths for preset sweep times with respect to preset central frequencies.

7. The radar apparatus according to claim 1, wherein the triangular wave generating unit changes the interval of at least one of the first modulated wave and the second modulated wave.

8. The radar apparatus according to claim 1, wherein the triangular wave generating unit determines the interval of at least one of the first modulated wave and the second modulated wave by a random number.

9. The radar apparatus according to claim 1, wherein the triangular wave generating unit determines the interval of at least one of the first modulated wave and the second modulated wave based on an output value having a deviation output from hardware constituting the radar apparatus or based on a calculation result using the output value of the hardware.

10. An on-board radar system comprising a plurality of radar apparatuses mounted on the front side of a vehicle,
wherein each of the plurality of radar apparatuses includes:
a transmitting antenna;
a triangular wave generating unit configured to generate a first modulated wave and a second modulated wave which are transmitted from the transmitting antenna at a predetermined interval;
a receiving antenna that receives radio waves obtained by causing an object to reflect the transmitted first and second modulated waves; and
a signal intensity calculating unit configured to make a determination, on peaks equal to or greater than a predetermined value appearing in received signals which are received by the receiving antenna and which correspond to the first and second modulated waves, as to whether the peaks are due to a signal obtained by causing the object to reflect the transmitted wave emitted from a host radar device or the peaks are due to a signal obtained by causing a reflecting object including the object to reflect the transmitted wave emitted from another radar device.

11. The on-board radar system according to claim 10, wherein each of the plurality of radar apparatuses transmits the first modulated wave and the second modulated wave, which are swept with preset modulation widths for preset sweep times with respect to preset central frequencies, from the transmitting antenna at different intervals.

12. The on-board radar system according to claim 10, wherein the signal intensity calculating unit transforms the received signals corresponding to the first and second modulated waves to a frequency spectrum, and
wherein the signal intensity calculating unit compares a frequency of the peak equal to or greater than a predetermined value appearing in the received signal corresponding to the first modulated wave and a frequency of the peak equal to or greater than a predetermined value appearing in the received signal corresponding to the second modulated wave, determines that the received signals are signals obtained by causing the object to reflect the transmitted waves emitted by the host radar device when the frequencies are values corresponding to the same distance, and determines that the received signals are signals obtained by causing a reflecting object including the object to reflect the transmitted waves emitted from another radar device when the frequencies are values not corresponding to the same distance.

13. The on-board radar system according to claim 10, wherein the signal intensity calculating unit transforms the received signals corresponding to the first and second modulated waves to a frequency spectrum, and
wherein the signal intensity calculating unit compares a frequency of the peak equal to or greater than a predetermined value appearing in the received signal corresponding to the first modulated wave and a frequency of the peak equal to or greater than a predetermined value appearing in the received signal corresponding to the second modulated wave, determines that the received signals are signals obtained by causing the object to reflect the transmitted waves emitted by the host radar device when the frequencies are values corresponding to the same distance and the same relative speed, and determines that the received signals are signals obtained by causing a reflecting object including the object to reflect the transmitted waves emitted from another radar device when the frequencies are values not corresponding to the same distance and the same relative speed.

14. The on-board radar system according to claim 12, further comprising:
a control unit configured to perform at least one of giving of an alarm notifying that an obstacle is present and a control of speed when the signal intensity calculating unit determines that the received signals are signals obtained by causing the object to reflect the transmitted waves emitted from the host radar device and configured not to perform giving of the alarm and the control of speed when the signal intensity calculating unit determines that the received signals are signals obtained by causing a reflecting object including the object to reflect transmitted waves emitted from another radar device.

15. The on-board radar system according to claim 13, further comprising:
a control unit configured to perform at least one of giving of an alarm notifying that an obstacle is present and a control of speed when the signal intensity calculating unit determines that the received signals are signals obtained by causing the object to reflect the transmitted waves emitted from the host radar device and configured not to perform giving of the alarm and the control of speed when the signal intensity calculating unit determines that the received signals are signals obtained by causing a reflecting object including the object to reflect transmitted waves emitted from another radar device.

16. A program causing a computer to perform:
transmitting a first modulated wave and a second modulated wave at a predetermined interval from a transmitting antenna; and
making a determination, on peaks equal to or greater than a predetermined value appearing in received signals which are received by the receiving antenna and which correspond to the first and second modulated waves, as to whether the peaks are due to a signal obtained by causing the object to reflect the transmitted wave emitted from a host radar device or the peaks are due to a signal obtained by causing a reflecting object including the object to reflect the transmitted wave emitted from another radar device.
